(19) United States
(12) Patent Application Publication
(10) Pub. No.: US 2013/0117026 A1
(43) Pub. Date: May 9, 2013

(54) SPEECH SYNTHESIZER, SPEECH SYNTHESIS METHOD, AND SPEECH SYNTHESIS PROGRAM

(71) Applicant: Masanori Kato, Tokyo (JP)

(72) Inventor: Masanori Kato, Tokyo (JP)

(73) Assignee: NEC CORPORATION, Tokyo (JP)

(21) Appl. No.: 13/809,515

(22) PCT Filed: Sep. 1, 2011
(86) PCT No.: PCT/JP2011/004918

§ 371 Date: Jan. 10, 2013

(30) Foreign Application Priority Data
Sep. 6, 2010 (JP) 2010-199229

(51) Int. Cl. G10L 13/08

(52) U.S. Cl. CPC G10L 13/08
USPC 704/260

(57) ABSTRACT

State duration creation means creates a state duration indicating a duration of each state in a hidden Markov model, based on linguistic information and a model parameter of prosody information. Duration correction degree computing means derives a speech feature from the linguistic information, and computes a duration correction degree which is an index indicating a degree of correcting the state duration, based on the derived speech feature. State duration correction means corrects the state duration based on a phonological duration correction parameter and the duration correction degree, the phonological duration correction parameter indicating a correction ratio of correcting a phonological duration.

### TECHNICAL FIELD

The present invention relates to a speech synthesizer, a speech synthesis method, and a speech synthesis program for synthesizing speech from text.

### BACKGROUND ART

Speech synthesizers for analyzing text sentences and creating synthesized speech from speech information indicated by the sentences are known. Applications of HMMs (Hidden Markov Models), which are widely used in the field of speech recognition, to such speech synthesizers have attracted attention in recent years.

FIG. 13 is an explanatory diagram for describing a HMM. As shown in FIG. 13, the HMM is defined as a model in which each signal source (state) whose probability distribution of outputting an output vector is bᵢ(oₜ) is connected with a state transition probability aᵢⱼ=P(qₜ=j|qₜ₋₁=i). Here, i and j are state numbers. The output vector oₜ is a parameter representing a short-time spectrum of speech such as a cepstrum or a linear prediction coefficient, a pitch frequency of speech, or the like. Since variations in a time direction and a parameter direction are statistically modeled in the HMM, the HMM is known to be suitable for expressing, as a parameter sequence, speech which varies due to various factors.

In a HMM-based speech synthesizer, first, prosody information (pitch (pitch frequency), duration (phonological duration)) of synthesized speech is created based on a text sentence analysis result. Next, a waveform creation parameter is acquired to create a speech waveform, based on the text analysis result and the created prosody information. Note that the waveform creation parameter is stored in a memory (waveform creation parameter storage unit) or the like.

Such a speech synthesizer includes a model parameter storage unit for storing model parameters of prosody information, as described in Non Patent Literatures (NPL) 1 to 3. When performing speech synthesis, the speech synthesizer acquires a model parameter for each state of the HMM from the model parameter storage unit and creates the prosody information, based on the text analysis result.

A speech synthesizer that creates synthesized speech by correcting phonological durations is described in Patent Literature (PTL) 1. In the speech synthesizer described in PTL 1, each individual phonological duration is multiplied by a ratio of an interpolation duration to total sum data of phonological durations, to compute a corrected phonological duration obtained by distributing an interpolation effect to each phonological duration. Each individual phonological duration is corrected through this process.

A speaking rate control method in a rule-based speech synthesizer is described in PTL 2. In the speaking rate control method described in PTL 2, the duration of each phoneme is computed, and a speaking rate is computed based on change rate data of the phoneme-specific duration with respect to a change in speaking rate obtained by analyzing actual speech.

### CITATION LIST

### Patent Literatures

PTL 1: Japanese Patent Application Laid-Open No. 2000-310996
PTL 2: Japanese Patent Application Laid-Open No. H4-170600

### Non Patent Literatures

NPL 1: Masuko, et al., “HMM-Based Speech Synthesis Using Dynamic Features”, IEICE Trans. D-II, Vol. J79-D-II, No. 12, pp. 2184-2190, December, 1996
NPL 2: Tokuda, “Fundamentals of Speech Synthesis Based on HMM”, IEICE Technical Report, Vol. 100, No. 392, pp. 43-50, October, 2000
NPL 3: H. Zen, et al., “A Hidden Semi-Markov Model-Based Speech Synthesis System”, IEICE Trans. INF. & SYST., Vol. E90-D, No. 5, pp. 825-834, 2007

### SUMMARY OF INVENTION

### Technical Problem

In the methods described in NPL 1 and NPL 2, the duration of each phoneme of synthesized speech is given by a total sum of durations of states belonging to the phoneme. For example, suppose the number of states of a phoneme is three, and durations of states 1 to 3 of a phoneme a are d1, d2, and d3. Then, the duration of the phoneme a is given by d1+d2+d3. The duration of each state is determined by a mean and a variance which constitute the model parameter, and a constant specified from the duration of the whole sentence. In detail, when the mean of the state 1 is denoted by m1, the variance of the state 1 by σ1, and the constant specified from the duration of the whole sentence by p, the state duration d1 of the state 1 can be computed according to the following equation 1.

d1=m1+ρ·σ1 (Equation 1)

Accordingly, in the case where σ is considerably greater than the mean and the variance, the state duration significantly depends on the variance. Thus, in the methods described in NPL 1 and NPL 2, the state durations of the HMM corresponding to the phonological duration are each determined based on the mean and the variance which constitute the model parameter of each state duration, with there being a problem that the duration in the state with a large variance tends to be long.

Typically, when analyzing natural speech of a syllable made up of a consonant and a vowel, the consonant part tends to be shorter in duration than the vowel part. However, if a state belonging to the consonant has a larger variance than a state belonging to the vowel, the syllable may have a longer duration in the consonant. Frequent occurrence of such syllables in which the consonant duration is longer than the vowel duration causes synthesized speech to have unnatural utterance rhythm, making the synthesized speech unintelligible. In such a case, it is difficult to create intelligible synthesized speech with natural utterance rhythm.

Even if the speech synthesizer described in PTL 1 is used, it is difficult to create a pitch pattern using a HMM, and therefore intelligible synthesized speech with high utterance rhythm naturalness is hard to be created.

In view of this, the present invention has an exemplary object of providing a speech synthesizer, a speech synthesis method, and a speech synthesis program that can create intelligible synthesized speech with high utterance rhythm naturalness.

### Solution to Problem

A speech synthesizer according to the present invention includes: state duration creation means for creating a state duration indicating a duration of each state in a hidden Markov model, based on linguistic information and a model parameter of prosody information; duration correction degree computing means for deriving a speech feature from the linguistic information, and computing a duration correction degree based on the derived speech feature, the duration correction degree being an index indicating a degree of correcting the state duration; and state duration correction means for correcting the state duration based on a phonological duration correction parameter and the duration correction degree, the phonological duration correction parameter indicating a correction ratio of correcting a phonological duration.

A speech synthesis method according to the present invention includes: creating a state duration indicating a duration of each state in a hidden Markov model, based on linguistic information and a model parameter of prosody information; deriving a speech feature from the linguistic information; computing a duration correction degree based on the derived speech feature, the duration correction degree being an index indicating a degree of correcting the state duration; and correcting the state duration based on a phonological duration correction parameter and the duration correction degree, the phonological duration correction parameter indicating a correction ratio of correcting a phonological duration.

A speech synthesis program according to the present invention causes a computer to execute: a state duration creation process of creating a state duration indicating a duration of each state in a hidden Markov model, based on linguistic information and a model parameter of prosody information; a duration correction degree computing process of deriving a speech feature from the linguistic information, and computing a duration correction degree based on the derived speech feature, the duration correction degree being an index indicating a degree of correcting the state duration; and a state duration correction process of correcting the state duration based on a phonological duration correction parameter and the duration correction degree, the phonological duration correction parameter indicating a correction ratio of correcting a phonological duration.

### Advantageous Effects of Invention

According to the present invention, intelligible synthesized speech with high utterance rhythm naturalness can be created.

### BRIEF DESCRIPTION OF DRAWINGS FIG. 1 It depicts a block diagram showing an example of a speech synthesizer in Exemplary Embodiment 1 of the present invention.

FIG. 2 It depicts a flowchart showing an example of an operation of the speech synthesizer in Exemplary Embodiment 1.

FIG. 3 It depicts a block diagram showing an example of a speech synthesizer in Exemplary Embodiment 2 of the present invention.

FIG. 4 It depicts an explanatory diagram showing an example of a correction degree in each state computed based on linguistic information.

FIG. 5 It depicts an explanatory diagram showing an example of a correction degree computed based on a provisional pitch pattern.

FIG. 6 It depicts an explanatory diagram showing an example of a correction degree computed based on a provisional pitch pattern.

FIG. 7 It depicts an explanatory diagram showing an example of a correction degree computed based on a speech waveform parameter.

FIG. 8 It depicts an explanatory diagram showing an example of a correction degree computed based on a speech waveform parameter.

FIG. 9 It depicts a flowchart showing an example of an operation of the speech synthesizer in Exemplary Embodiment 2.

FIG. 10 It depicts a block diagram showing an example of a speech synthesizer in Exemplary Embodiment 3 of the present invention.

FIG. 11 It depicts a flowchart showing an example of an operation of the speech synthesizer in Exemplary Embodiment 3.

FIG. 12 It depicts a block diagram showing an example of a minimum structure of a speech synthesizer according to the present invention.

FIG. 13 It depicts an explanatory diagram for describing a HMM.

### DESCRIPTION OF EMBODIMENT(S)

The following describes exemplary embodiments of the present invention with reference to drawings.

### Exemplary Embodiment 1

FIG. 1 is a block diagram showing an example of a speech synthesizer in Exemplary Embodiment 1 of the present invention. The speech synthesizer in this exemplary embodiment includes a language processing unit 1, a prosody creation unit 2, a segment information storage unit 12, a segment selection unit 4, and a waveform creation unit 5. The prosody creation unit 2 includes a state duration creation unit 21, a state duration correction unit 22, a phoneme duration computing unit 23, a duration correction degree computing unit 24, a model parameter storage unit 25, and a pitch pattern creation unit 3.

The segment information storage unit 12 stores segments created on a speech synthesis unit basis, and attribute information of each segment. A segment is information indicating a speech waveform of a speech synthesis unit, and is expressed by the waveform itself, s parameter (e.g. spectrum, cepstrum, linear prediction filter coefficient) extracted from the waveform, or the like. In more detail, a segment is a speech waveform divided (clipped) on a speech synthesis unit basis, time series of a waveform creation parameter extracted from the clipped speech waveform as typified by a linear prediction analysis parameter or a cepstrum coefficient, or the like. In many cases, a phoneme is created, for example, based on information extracted from human-produced speech (also referred to as “natural speech waveform”). For instance, a phoneme is created from information obtained by recording speech produced (uttered) by an announcer or a voice actor.

The speech synthesis unit is arbitrary, and may be, for example, a phoneme, a syllable, or the like. The speech synthesis unit may also be a CV unit, a VCV unit, a CVC unit, or the like determined based on phonemes, as described in the following References 1 and 2. Alternatively, the speech synthesis unit may be a unit determined based on a COC method. Here, V represents a vowel, and C represents a consonant.

### <Reference 1>

Huang, Acero, Hon, “Spoken Language Processing”, Prentice Hall, pp. 689-836, 2001

### <Reference 2>

Abe, et al., “An Introduction to Speech Synthesis Units”, IEICE Technical Report, Vol. 100, No. 392, pp. 35-42, 2000

The language processing unit 1 performs analysis such as morphological analysis, parsing, attachment of reading, and the like on input text (character string information), to create linguistic information. The linguistic information created by the language processing unit 1 includes at least information indicating “reading” such as a syllable symbol and a phoneme symbol. The language processing unit 1 may create the linguistic information that includes information indicating “Japanese grammar” such as a part-of-speech and a conjugate type of a morpheme and “accent information” indicating an accent type, an accent position, an accentual phrase pause, and the like, in addition to the above-mentioned information indicating “reading”. The language processing unit 1 inputs the created linguistic information to the state duration creation unit 21, the pitch pattern creation unit 3, and the segment selection unit 4.

Note that the contents of the accent information and the morpheme information included in the linguistic information differ depending on the exemplary embodiment in which the below-mentioned state duration creation unit 21, pitch pattern creation unit 3, and segment selection unit 4 use the linguistic information.

The model parameter storage unit 25 stores model parameters of prosody information. In detail, the model parameter storage unit 25 stores model parameters of state durations. The model parameter storage unit 25 may store model parameters of pitch frequencies. The model parameter storage unit 25 stores model parameters according to prosody information beforehand. As the model parameters, model parameters obtained by modeling prosody information by HMMs beforehand are used as an example.

The state duration creation unit 21 creates a state duration based on the linguistic information input from the language processing unit 1 and a model parameter stored in the model parameter storage unit 25. Here, the duration of each state belonging to a phoneme is uniquely determined based on information called “context” such as mora positions of phonemes (also called “preceding and succeeding phonemes”) before and after the phoneme (hereafter referred to as “current phoneme”) and the current phoneme in accentual phrases, mora lengths and accent types of the accentual phrases to which the preceding, current, and succeeding phonemes belong, and a position of the accentual phrase to which the current phoneme belongs. That is, a model parameter is uniquely determined for arbitrary context information. In detail, the model parameter includes a mean and a variance.

Accordingly, the state duration creation unit 21 selects the model parameter from the model parameter storage unit 25 based on the analysis result of the input text, and creates the state duration based on the selected model parameter, as described in NPL 1 to NPL 3. The state duration creation unit 21 inputs the created state duration to the state duration correction unit 22. The state duration mentioned here is a duration for which each state in a HMM continues.

The model parameter of the state duration stored in the model parameter storage unit 25 corresponds to a parameter for characterizing a state duration probability of a HMM. As described in NPL 1 to NPL 3, a state duration probability of a HMM is a probability of the number of times a state continues (i.e. self-transitions), and is often defined by a Gaussian distribution. A Gaussian distribution is characterized by two types of statistics, namely, a mean and a variance. Hence, it is assumed in this exemplary embodiment that the model parameter of the state duration is a mean and a variance of a Gaussian distribution. A mean ζⱼ and a variance σ²ⱼ of the state duration of the HMM are computed according to the following equation 2. The state duration created here matches the mean of the model parameter, as described in NPL 3.

$$[ Math . 1 ]$$

$${ξ}_{j} = \frac{{\sum }_{t 0 = 1}^{T} {\sum }_{t 1 = t 0}^{T} {x}_{t 0 , t 1} ( j ) \cdot ( {t }_{1} - {t}_{0} + 1 )}{{\sum }_{t 0 = 1}^{T} {\sum }_{t 1 = t 0}^{T} {x}_{t 0 , t 1} ( j )} \\ {σ}_{j}^{2} = \frac{{\sum }_{t 0 = 1}^{T} {\sum }_{t 1 = t 0}^{T} {x}_{t 0 , t 1} ( j ) \cdot {( {t }_{1} - {t}_{0} + 1 )}^{2}}{{\sum }_{t 0 = 1}^{T} {\sum }_{t 1 = t 0}^{T} {x}_{t 0 , t 1} ( j )} - {ξ}_{j}^{2} \qquad ( Equation 2 )$$

Note that the model parameter of the state duration is not limited to a mean and a variance of a Gaussian distribution. For example, the model parameter of the state duration may be estimated based on an EM algorithm using a state transition probability aᵢⱼ=P(qₜ=j|qₜ₋₁=i) and an output probability distribution bᵢ(oₜ) of the HMM, as described in Section 2.2 in NPL 2.

HMM parameters, which are not limited to the model parameter of the state duration, are computed by learning. Speech data and its phoneme label and linguistic information are used for such learning. Since the state duration model parameter learning method is a known technique, its detailed description is omitted.

The state duration creation unit 21 may compute the duration of each state, after determining the duration of the whole sentence (see NPL 1 and NPL 2). However, the above-mentioned method is more preferable because a state duration for realizing a standard speaking rate can be computed by computing the state duration matching the mean of the model parameter.

The duration correction degree computing unit 24 computes a duration correction degree (hereafter also simply referred to as “correction degree”) based on the linguistic information input from the language processing unit 1, and inputs the duration correction degree to the state duration correction unit 22. In detail, the duration correction degree computing unit 24 computes a speech feature from the linguistic information input from the language processing unit 1, and computes the duration correction degree based on the speech feature. The duration correction degree is an index indicating to what degree the below-mentioned state duration correction unit 22 is to correct the state duration of the HMM. When the correction degree is larger, the amount of correction of the state duration by the state duration correction unit 22 is larger. The duration correction degree is computed for each state.

As described above, the correction degree is a value related to the speech feature such as a spectrum or a pitch and its temporal change degree. The speech feature mentioned here does not include information indicating a time length (hereafter referred to as “time length information”). For example, the duration correction degree computing unit 24 sets a large correction degree for a part that is estimated to have a small temporal change degree of the speech feature. The duration correction degree computing unit 24 also sets a large correction degree for a part that is estimated to have a large absolute value of the speech feature.

This exemplary embodiment describes a method in which the duration correction degree computing unit 24 estimates the temporal change degree of the spectrum or the pitch representing the speech feature from the linguistic information, and computes the correction degree based on the estimated temporal change degree of the speech feature.

For instance, in the case of performing correction on a specific syllable, it is expected that, of a consonant and a vowel, the vowel typically has a smaller temporal change of the speech feature. It is also expected that a center part of the vowel has a smaller temporal change than both ends of the vowel. Accordingly, the duration correction degree computing unit 24 computes such a correction degree that decreases in the order of the vowel center, the vowel ends, and the consonant. In more detail, the duration correction degree computing unit 24 computes such a correction degree that is uniform in the consonant. The duration correction degree computing unit 24 also computes such a correction degree that decreases from the center to both ends (starting end and terminating end) in the vowel.

In the case of determining the correction degree on a syllable basis, the duration correction degree computing unit 24 decreases the correction degree from a center to both ends of the syllable. The duration correction degree computing unit 24 may compute the correction degree according to the phoneme type. For example, of consonants, a nasal has a smaller temporal change degree of the speech feature than a plosive. The duration correction degree computing unit 24 accordingly sets a larger correction degree for the nasal than the plosive.

In the case where the accent information such as an accent kernel position and an accentual phrase pause is included in the linguistic information, the duration correction degree computing unit 24 may use such information for computing the correction degree. As an example, since there is a large pitch change near the accent kernel or the accentual phrase pause, the duration correction degree computing unit 24 decreases the correction degree near the part.

A method of setting the correction degree separately for a voiced sound and a voiceless sound is also effective in some cases. Whether or not this distinction is effective relates to the synthesized speech waveform creation process. The waveform creation method tends to be significantly different between the voiced sound and the voiceless sound. Particularly in the voiceless sound waveform creation method, speech quality degradation associated with a time length extension and reduction process can be problematic. In such a case, it is desirable to set a smaller correction degree for the voiceless sound than the voiced sound.

In this exemplary embodiment, it is assumed that the correction degree is eventually determined on a state basis, and directly used by the state duration correction unit 22. In detail, the correction degree is a real number greater than 0.0, and is minimum when 0.0. In the case of performing such correction that increases the state duration, the correction degree is a real number greater than 1.0. In the case of performing such correction that decreases the state duration, the correction degree is a real number less than 1.0 and greater than 0.0. However, the correction degree is not limited to the above-mentioned values. For example, the minimum correction degree may be 1.0 both in the case of performing such correction that increases the state duration and in the case of performing such correction that decreases the state duration. Moreover, the position to be corrected may be expressed by a relative position such as the starting end, the terminating end, and the center of a syllable or a phoneme.

Furthermore, the correction degree is not limited to numeric values. For example, the correction degree may be defined by appropriate symbols (e.g. “large, medium, small”, “a, b, c, d, e”) for representing the degree of correction. In this case, the process of converting such a symbol to a real number on a state basis may be performed in the process of actually computing the correction value.

The state duration correction unit 22 corrects the state duration based on the state duration input from the state duration creation unit 21, the duration correction degree input from the duration correction degree computing unit 24, and a phonological duration correction parameter input by the user or the like. The state duration correction unit 22 inputs the corrected state duration to the phoneme duration computing unit 23 and the pitch pattern creation unit 3.

The phonological duration correction parameter is a value indicating a correction ratio for correcting the created phonological duration. The duration also includes the duration of a phoneme, a syllable, or the like computed by adding the state duration. The phonological duration correction parameter can be defined as the result of dividing the corrected duration by the pre-correction duration and its approximate value. Note that the phonological duration correction parameter is defined not on a HMM state basis but on a phoneme basis or the like. In detail, one phonological duration correction parameter may be defined for a specific phoneme or half-phoneme, or defined for a plurality of phonemes. Moreover, a common phonological duration correction parameter may be defined for the plurality of phonemes, or separate phonological duration correction parameters may be defined for the plurality of phonemes. Furthermore, one phonological duration correction parameter may be defined for the whole word, breath group, or sentence. It is thus assumed that the phonological duration correction parameter is not set for a specific state (i.e. each state indicating a phoneme) in a specific phoneme.

A value determined by the user, another device used in combination with the speech synthesizer, another function of the speech synthesizer, or the like is used as the phonological duration correction parameter. For example, in the case where the user hears synthesized speech and wants the speech synthesizer to output speech (speak) more slowly, the user may set a larger value as the phonological duration correction parameter. In the case where the user wants the speech synthesizer to slowly output (speak) a keyword in a sentence selectively, the user may set the phonological duration correction parameter for the keyword separately from normal utterance.

As mentioned above, the duration correction degree is larger in the part that is estimated to have a smaller temporal change degree of the speech feature. Accordingly, the state duration correction unit 22 applies a larger degree of change to a state duration of a state in which the temporal change degree of the speech feature is smaller.

In detail, the state duration correction unit 22 computes the correction amount for each state, based on the phonological duration correction parameter, the duration correction degree, and the pre-correction state duration. Let N be the number of states of a phoneme, m(1), m(2), . . . , m(N) be the pre-correction state duration, α(1), α(2), . . . , α(N) be the correction degree, and ρ be the input phonological duration correction parameter. Then, the correction amount l(1), l(2), . . . , l(N) for each state is given by the following equation 3.

$$[ Math . 2 ]$$

$$l ( i ) = \frac{( ρ - 1 ) {\sum }_{j = 1}^{N} m ( j )}{{\sum }_{j = 1}^{N} α ( j )} \cdot α ( i ) , for i = 1 , 2 , … , N \qquad ( Equation 3 )$$

The state duration correction unit 22 adds the computed correction amount to the pre-correction state duration, to obtain the corrected value. Let N be the number of states of a phoneme, m(1), m(2), . . . , m(N) be the pre-correction state duration, α(1), α(2), . . . , α(N) be the correction degree, and ρ be the input phonological duration correction parameter, in the same manner as above. Then, the corrected state duration is given by the following equation 4.

$$[ Math . 3 ]$$

$$n ( i ) = m ( i ) + \frac{( ρ - 1 ) {\sum }_{j = 1}^{N} m ( j )}{{\sum }_{j = 1}^{N} α ( j )} \cdot α ( i ) , for i = 1 , 2 , … , N \qquad ( Equation 4 )$$

In the case where one phonological duration correction parameter ρ is designated for a sequence of a plurality of phonemes, the state duration correction unit 22 may compute the correction amount using the above-mentioned equation, for all states included in the phoneme sequence. In the case where the number of states is M in total, the state duration correction unit 22 may compute the correction amount using M instead of N in the above-mentioned equation 4.

Moreover, the state duration correction unit 22 may compute the corrected value by multiplying the pre-correction state duration by the computed correction amount. For example, in the case of computing the correction amount using the following equation 5, the state duration correction unit 22 may compute the corrected value by multiplying the pre-correction state duration by the computed correction amount. Note that the method of computing the corrected value may be determined according to the method of computing the correction amount.

$$[ Math . 4 ]$$

$${l}^{′} ( i ) = 1 + \frac{( ρ - 1 ) {\sum }_{j = 1}^{N} m ( j )}{{\sum }_{j = 1}^{N} α ( j )} \cdot \frac{α ( i )}{m ( j )} , for i = 1 , 2 , … , N \qquad ( Equation 5 )$$

The phoneme duration computing unit 23 computes the duration of each phoneme based on the state duration input from the state duration correction unit 22, and inputs the computation result to the segment selection unit 4 and the waveform creation unit 5. The duration of each phoneme is given by a total sum of state durations of all states belonging to the phoneme. Accordingly, the phoneme duration computing unit 23 computes the duration of each phoneme, by computing the total sum of state durations of the phoneme.

The pitch pattern creation unit 3 creates a pitch pattern based on the linguistic information input from the language processing unit 1 and the state duration input from the state duration correction unit 22, and inputs the pitch pattern to the segment selection unit 4 and the waveform creation unit 5. For example, the pitch pattern creation unit 3 may create the pitch pattern by modeling the pitch pattern by a MSD-HMM (Multi-Space Probability Distribution-HMM), as described in NPL 2. The method of creating the pitch pattern by the pitch pattern creation unit 3 is, however, not limited to the above-mentioned method. The pitch pattern creation unit 3 may model the pitch pattern by a HMM. Since these methods are widely known, their detailed description is omitted.

The segment selection unit 4 selects, from the segments stored in the segment information storage unit 12, an optimal segment for synthesizing speech based on the language analysis result, the phoneme duration, and the pitch pattern, and inputs the selected segment and its attribute information to the waveform creation unit 5.

If the duration and the pitch pattern created from the input text are strictly applied to the synthesized speech waveform, the created duration and pitch pattern can be called prosody information of synthesized speech. In actuality, however, a similar prosody (i.e. duration and pitch pattern) is applied. This being so, the created duration and pitch pattern can be regarded as prosody information targeted when creating the speech synthesis waveform. Hence, the created duration and pitch pattern are hereafter also referred to as “target prosody information”.

The segment selection unit 4 obtains, for each speech synthesis unit, information (hereafter referred to as “target segment environment”) indicating the feature of the synthesized speech, based on the input language analysis result and target prosody information. The target segment environment includes the current phoneme, the preceding phoneme, the succeeding phoneme, the presence or absence of stress, a distance from the accent kernel, a pitch frequency per speech synthesis unit, power, a duration per unit, a cepstrum, MFCC (Mel Frequency Cepstral Coefficients), their A amounts (change amounts per unit time), and the like.

Next, the segment selection unit 4 acquires a plurality of segments each having a phoneme corresponding to (e.g. matching) specific information (mainly, the current phoneme) included in the obtained target segment environment, from the segment information storage unit 12. The acquired segments are candidates for the segment used for speech synthesis.

The segment selection unit 4 then computes, for each acquired segment, a cost which is an index indicating appropriateness as the segment used for speech synthesis. The cost is obtained by quantifying differences between the target segment environment and the candidate segment or between attribute information of adjacent candidate segments, and is smaller when the similarity is higher, that is, when the appropriateness for speech synthesis is higher. The use of a segment having a smaller cost enables creation of synthesized speech that is higher in naturalness which represents its similarity to human-produced speech. The segment selection unit 4 accordingly selects a segment whose computed cost is smallest.

In detail, the cost computed by the segment selection unit 4 includes a unit cost and a concatenation cost. The unit cost represents estimated speech quality degradation caused by using the candidate segment in the target segment environment, and is computed based on similarity between a segment environment of the candidate segment and the target segment environment. The concatenation cost represents estimated speech quality degradation caused by discontinuity between segment environments of concatenated speech segments, and is computed based on affinity between segment environments of adjacent candidate segments. Various methods have hitherto been proposed for the computation of the unit cost and the concatenation cost. Typically, information included in the target segment environment is used for the computation of the unit cost. On the other hand, a pitch frequency, a cepstrum, MFCC, short-time self correlation, and power in a segment concatenation boundary, their A amounts, and the like are used for the computation of the concatenation cost. Thus, the unit cost and the concatenation cost are computed using a plurality of types of information (pitch frequency, cepstrum, power, etc.) relating to the segment.

After computing the unit cost and the concatenation cost for each segment, the segment selection unit 4 uniquely determines a speech segment that is smallest in both concatenation cost and unit cost, for each synthesis unit. This segment determined by cost minimization is a segment selected as optimal for speech synthesis from among the candidate segments, and so may also be referred to as “selected segment”.

The waveform creation unit 5 creates synthesized speech by concatenating segments selected by the segment selection unit 4. The waveform creation unit 5 may not simply concatenate the segments, but create a speech waveform having a prosody matching or similar to the target prosody, based on the target prosody information input from the prosody creation unit 2, the selected segment input from the segment selection unit 4, and the segment attribute information. The waveform creation unit 5 may then concatenate each created speech waveform to create synthesized speech. For example, a PSOLA (pitch synchronous overlap-add) method described in Reference 1 may be used as the method of creating synthesized speech by the waveform creation unit 5. However, the method of creating synthesized speech by the waveform creation unit 5 is not limited to the above-mentioned method. Since the method of creating synthesized speech from selected segments is widely known, its detailed description is omitted.

For example, the segment information storage unit 12 and the model parameter storage unit 25 are realized by a magnetic disk or the like. The language processing unit 1, the prosody creation unit 2 (more specifically, the state duration creation unit 21, the state duration correction unit 22, the phoneme duration computing unit 23, the duration correction degree computing unit 24, and the pitch pattern creation unit 3), the segment selection unit 4, and the waveform creation unit 5 are realized by a CPU of a computer operating according to a program (speech synthesis program). As an example, the program may be stored in a storage unit (not shown) in the speech synthesizer, with the CPU reading the program and, according to the program, operating as the language processing unit 1, the prosody creation unit 2 (more specifically, the state duration creation unit 21, the state duration correction unit 22, the phoneme duration computing unit 23, the duration correction degree computing unit 24, and the pitch pattern creation unit 3), the segment selection unit 4, and the waveform creation unit 5. Alternatively, the language processing unit 1, the prosody creation unit 2 (more specifically, the state duration creation unit 21, the state duration correction unit 22, the phoneme duration computing unit 23, the duration correction degree computing unit 24, and the pitch pattern creation unit 3), the segment selection unit 4, and the waveform creation unit 5 may each be realized by dedicated hardware.

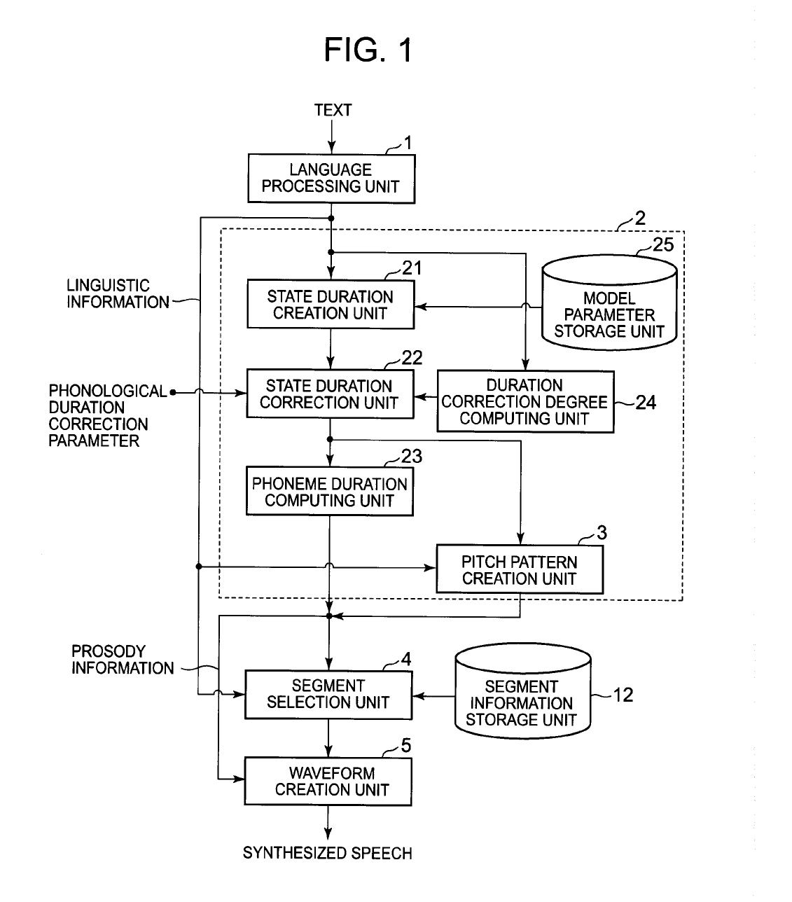

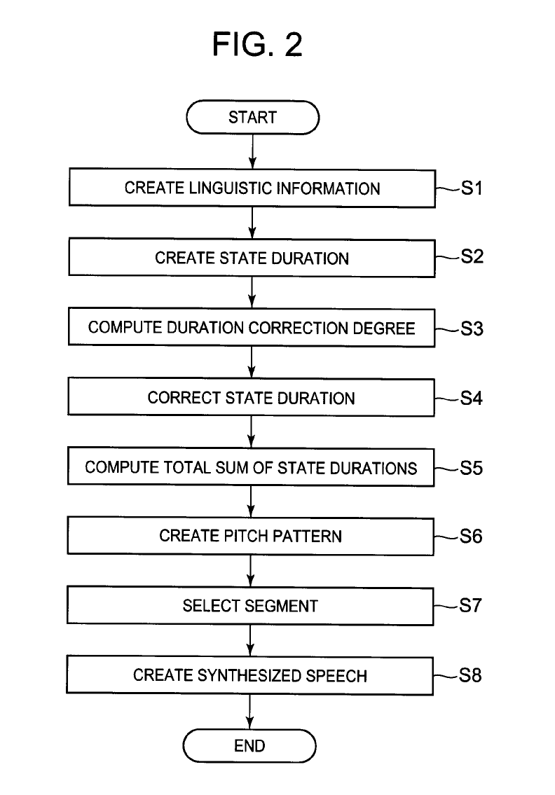

The following describes an operation of the speech synthesizer in this exemplary embodiment. FIG. 2 is a flowchart showing an example of the operation of the speech synthesizer in Exemplary Embodiment 1. First, the language processing unit 1 creates the linguistic information from the input text (step S1). The state duration creation unit 21 creates the state duration, based on the linguistic information and the model parameter (step S2). The duration correction degree computing unit 24 computes the duration correction degree, based on the linguistic information (step S3).

The state duration correction unit 22 corrects the state duration, based on the state duration, the duration correction degree, and the phonological duration correction parameter (step S4). The phoneme duration computing unit 23 computes the total sum of state durations, based on the corrected state duration (step S5). The pitch pattern creation unit 3 creates the pitch pattern, based on the linguistic information and the corrected state duration (step S6). The segment selection unit 4 selects the segment used for speech synthesis, based on the linguistic information which is the analysis result of the input text, the total sum of state durations, and the pitch pattern (step S7). The waveform creation unit 5 creates the synthesized speech by concatenating the selected segments (step S8).

As described above, according to this exemplary embodiment, the state duration creation unit 21 creates the state duration of each state in the HMM, based on the linguistic information and the model parameter of the prosody information. Moreover, the duration correction degree computing unit 24 computes the duration correction degree, based on the speech feature derived from the linguistic information. The state duration correction unit 22 then corrects the state duration, based on the phonological duration correction parameter and the duration correction degree.

Thus, according to this exemplary embodiment, the correction degree is computed from the speech feature estimated based on the linguistic information and its change degree, and the state duration is corrected according to the phonological duration correction parameter based on the correction degree. As a result, intelligible synthesized speech with high utterance rhythm naturalness can be created compared with ordinary speech synthesizers.

For instance, consider the case where, instead of correcting the state duration as described in this exemplary embodiment, the phoneme duration is corrected as described in PTL 1. In such a case, after creating the pitch pattern and creating the phoneme duration, the phoneme duration is corrected and lastly the pitch pattern is corrected. This, however, incurs a possibility that inappropriate deformation is made in the last pitch pattern correction, resulting in creation of a pitch pattern which is problematic in terms of speech quality. Suppose, for example, the phoneme duration is divided at equal intervals when computing the state duration from the corrected phoneme duration. In this case, there is a possibility that the pitch pattern is shaped inappropriately, causing a decrease in quality of synthesized speech. In the case where the phoneme duration becomes longer as a result of correction, it is desirable in terms of speech quality to extend the pitch pattern at the syllable center without extending the pitch pattern at the syllable starting or terminating end, as compared with extending the entire pitch pattern equally. This is because, when observing natural speech, there is a tendency that the syllable ends have a larger pitch change than the syllable center. Though a method of simply assigning such a duration that is “shorter at the syllable ends and longer at the syllable center” is also conceivable, it is not adequate to apply such a method of newly creating the state duration while ignoring the result (i.e. pre-correction state duration) of modeling with HMMs and learning a large amount of speech data.

In this exemplary embodiment, on the other hand, after correcting the state duration, the pitch pattern is created and the phoneme duration is created. This can suppress the above-mentioned inappropriate deformation. Moreover, in this exemplary embodiment, not only the model parameter such as the mean and the variance but also the speech feature indicating the property of natural speech is used when determining the state duration. Therefore, synthesized speech with high naturalness can be created.

### Exemplary Embodiment 2

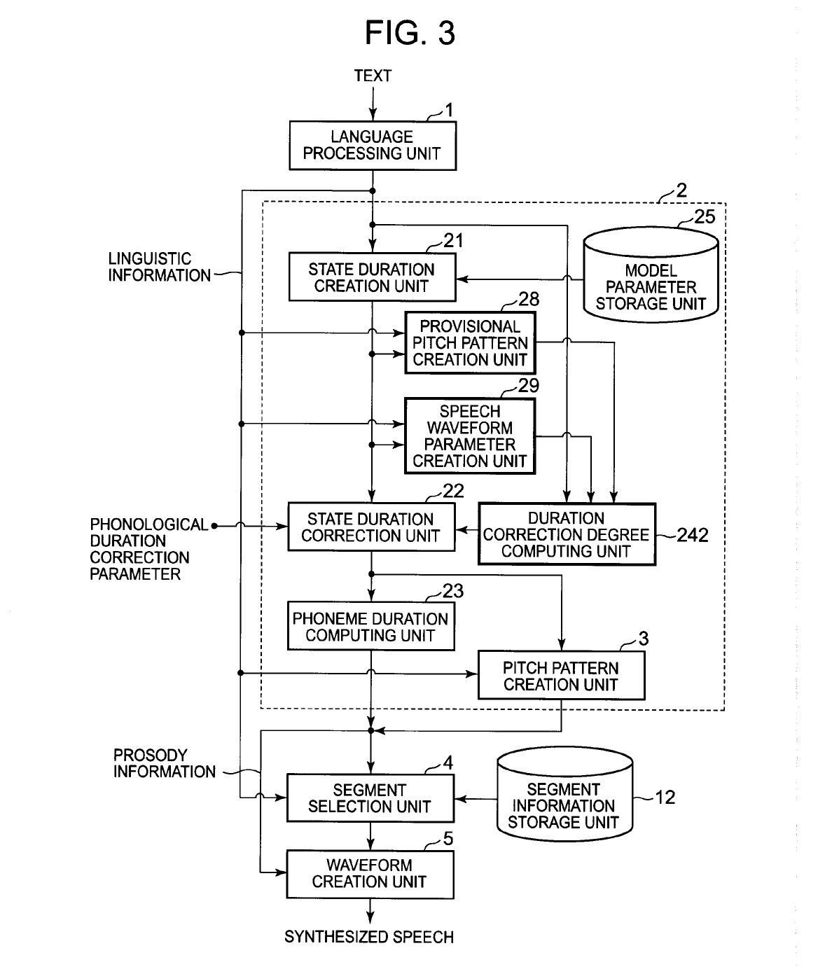

FIG. 3 is a block diagram showing an example of a speech synthesizer in Exemplary Embodiment 2 of the present invention. The same components as those in Exemplary Embodiment 1 are given the same reference signs as in FIG. 1, and their description is omitted. The speech synthesizer in this exemplary embodiment includes the language processing unit 1, the prosody creation unit 2, the segment information storage unit 12, the segment selection unit 4, and the waveform creation unit 5. The prosody creation unit 2 includes the state duration creation unit 21, the state duration correction unit 22, the phoneme duration computing unit 23, a duration correction degree computing unit 242, a provisional pitch pattern creation unit 28, a speech waveform parameter creation unit 29, the model parameter storage unit 25, and the pitch pattern creation unit 3.

That is, the speech synthesizer exemplified in FIG. 3 differs from that in Exemplary Embodiment 1, in that the duration correction degree computing unit 24 is replaced with the duration correction degree computing unit 242, and the provisional pitch pattern creation unit 28 and the speech waveform parameter creation unit 29 are newly included.

The provisional pitch pattern creation unit 28 creates a provisional pitch pattern based on the linguistic information input from the language processing unit 1 and the state duration input from the state duration creation unit 21, and inputs the provisional pitch pattern to the duration correction degree computing unit 242. The method of creating the pitch pattern by the provisional pitch pattern creation unit 28 is the same as the method of creating the pitch pattern by the pitch pattern creation unit 3.

The speech waveform parameter creation unit 29 creates a speech waveform parameter based on the linguistic information input from the language processing unit 1 and the state duration input from the state duration creation unit 21, and inputs the speech waveform parameter to the duration correction degree computing unit 242. In detail, the speech waveform parameter is a parameter used for speech waveform creation, such as a spectrum, a cepstrum, and a linear prediction coefficient. The speech waveform parameter creation unit 29 may create the speech waveform parameter using a HMM. As an alternative, the speech waveform parameter creation unit 29 may create the speech waveform parameter using, for example, a mel-cepstrum as described in NPL 1. Since these methods are widely known, their detailed description is omitted.

The duration correction degree computing unit 242 computes the duration correction degree based on the linguistic information input from the language processing unit 1, the provisional pitch pattern input from the provisional pitch pattern creation unit 28, and the speech waveform parameter input from the speech waveform parameter creation unit 29, and inputs the duration correction degree to the state duration correction unit 22. As in Exemplary Embodiment 1, the correction degree is a value related to a speech feature such as a spectrum or a pitch and its temporal change degree. However, this exemplary embodiment differs from Exemplary Embodiment 1 in that the duration correction degree computing unit 242 estimates the speech feature and the temporal change degree of the speech feature based on not only the linguistic information but also the provisional pitch pattern and the speech waveform parameter and reflects the estimation result on the correction degree.

The duration correction degree computing unit 242 first computes the correction degree using the linguistic information. The duration correction degree computing unit 242 then computes the refined correction degree based on the provisional pitch pattern and the speech waveform parameter. Computing the correction degree in this way increases the amount of information used for estimating the speech feature. As a result, the speech feature can be estimated more accurately and finely than in Exemplary Embodiment 1. Given that the correction degree computed first by the duration correction degree computing unit 242 using the linguistic information is later refined based on the provisional pitch pattern and the speech waveform parameter, the correction degree computed first may also be referred to as “approximate correction degree”.

As described above, in this exemplary embodiment as in Exemplary Embodiment 1, the temporal change degree of the speech feature is estimated and the estimation result is reflected on the correction degree. The method of computing the correction degree by the duration correction degree computing unit 242 is further described below.

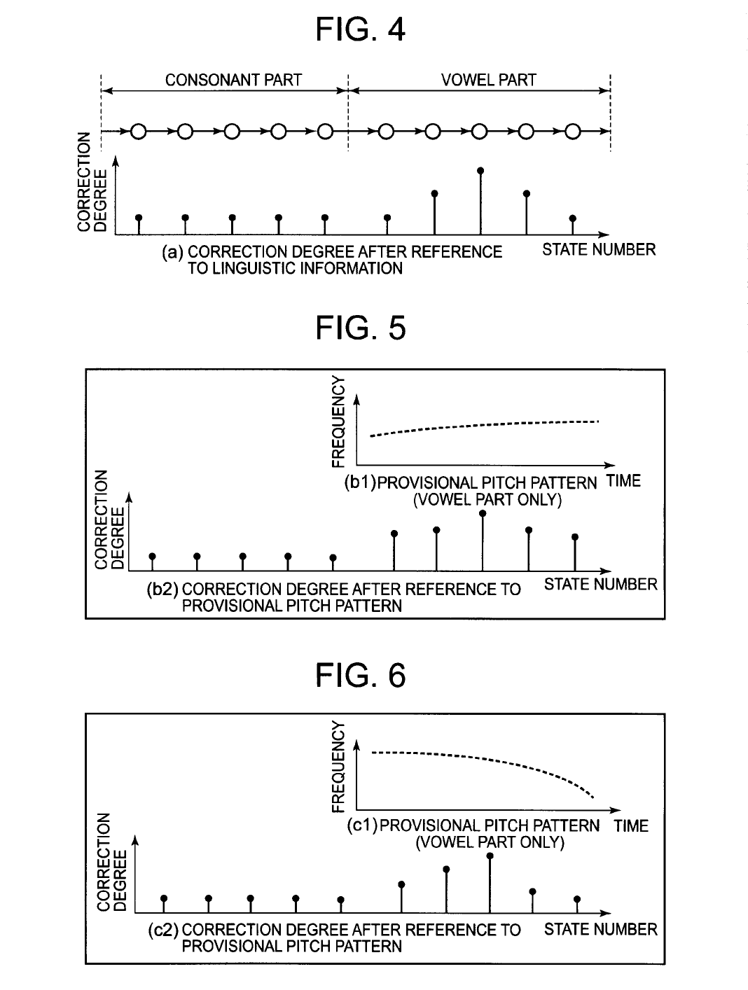

FIG. 4 is an explanatory diagram showing an example of a correction degree in each state computed based on linguistic information. Of ten states exemplified in FIG. 4, the first five states represent states of a phoneme indicating a consonant part, whereas the latter five states represent states of a phoneme indicating a vowel part. That is, the number of states per phoneme is assumed to be five. The correction degree is higher in the upward direction. In the following description, it is assumed that the correction degree computed using the linguistic information is uniform in the consonant and decreases from the center to both ends of the vowel, as exemplified in FIG. 4.

FIG. 5 is an explanatory diagram showing an example of a correction degree computed based on a provisional pitch pattern in the vowel part. In the case where the provisional pitch pattern in the vowel part has a shape as shown in (b1) in FIG. 5, the pitch pattern change degree is small as a whole. Accordingly, the duration correction degree computing unit 242 increases the correction degree of the vowel part as a whole. In detail, the correction degree exemplified in FIG. 4 is eventually changed to the correction degree as shown in (b2) in FIG. 5.

FIG. 6 is an explanatory diagram showing an example of a correction degree computed based on another provisional pitch pattern in the vowel part. In the case where the provisional pitch pattern in the vowel part has a shape as shown in (c1) in FIG. 6, the pitch pattern change degree is small in the first half to the center of the vowel and large in the latter half of the vowel. Accordingly, the duration correction degree computing unit 242 increases the correction degree of the first half to the center of the vowel, and decreases the correction degree of the latter half of the vowel. In detail, the correction degree exemplified in FIG. 4 is eventually changed to the correction degree as shown in (c2) in FIG. 6.

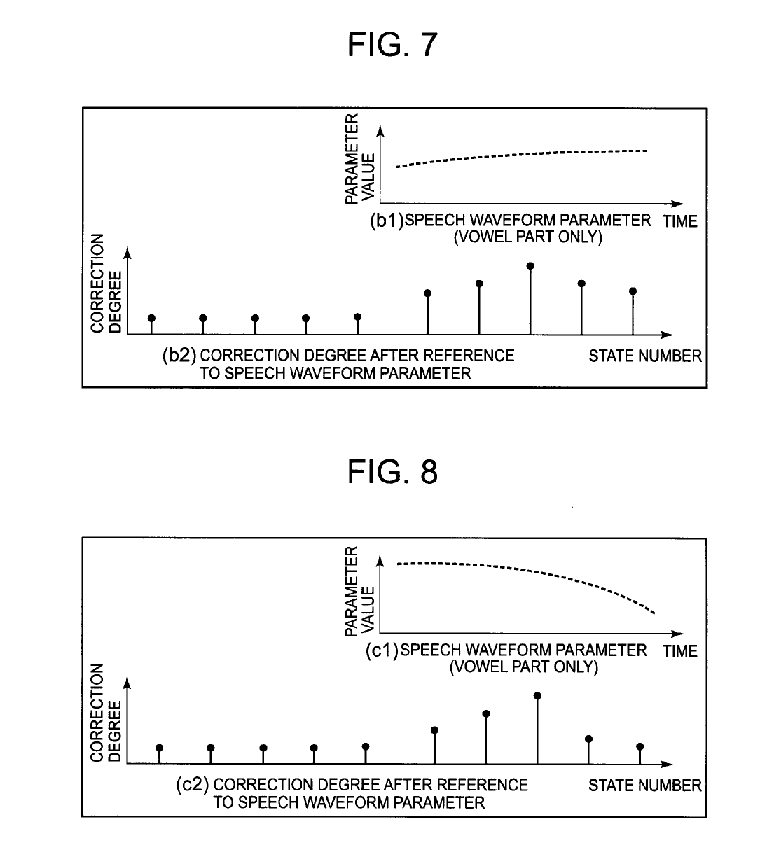

FIG. 7 is an explanatory diagram showing an example of a correction degree computed based on a speech waveform parameter in the vowel part. In the case where the speech waveform parameter in the vowel part has a shape as shown in (b1) in FIG. 7, the speech waveform parameter change degree is small as a whole. Accordingly, the duration correction degree computing unit 242 increases the correction degree of the vowel part as a whole. In detail, the correction degree exemplified in FIG. 4 is changed to the correction degree as shown in (b2) in FIG. 7.

FIG. 8 is an explanatory diagram showing an example of a correction degree computed based on another speech waveform parameter in the vowel part. In the case where the speech waveform parameter in the vowel part has a shape as shown in (c1) in FIG. 8, the speech waveform parameter change degree is small in the first half to the center of the vowel and large in the latter half of the vowel. Accordingly, the duration correction degree computing unit 242 increases the correction degree of the first half to the center of the vowel, and decreases the correction degree of the latter half of the vowel. In detail, the correction degree exemplified in FIG. 4 is changed to the correction degree as shown in (c2) in FIG. 8.

Though FIGS. 7 and 8 each exemplify the speech waveform parameter in one dimension, the speech waveform parameter is actually a multi-dimensional vector in many cases. In such a case, the duration correction degree computing unit 242 may compute the mean or the total sum for each frame and use the one-dimensionally converted value for correction.

The language processing unit 1, the prosody creation unit 2 (more specifically, the state duration creation unit 21, the state duration correction unit 22, the phoneme duration computing unit 23, the duration correction degree computing unit 242, the provisional pitch pattern creation unit 28, the speech waveform parameter creation unit 29, and the pitch pattern creation unit 3), the segment selection unit 4, and the waveform creation unit 5 are realized by a CPU of a computer operating according to a program (speech synthesis program). Alternatively, the language processing unit 1, the prosody creation unit 2 (more specifically, the state duration creation unit 21, the state duration correction unit 22, the phoneme duration computing unit 23, the duration correction degree computing unit 242, the provisional pitch pattern creation unit 28, the speech waveform parameter creation unit 29, and the pitch pattern creation unit 3), the segment selection unit 4, and the waveform creation unit 5 may each be realized by dedicated hardware.

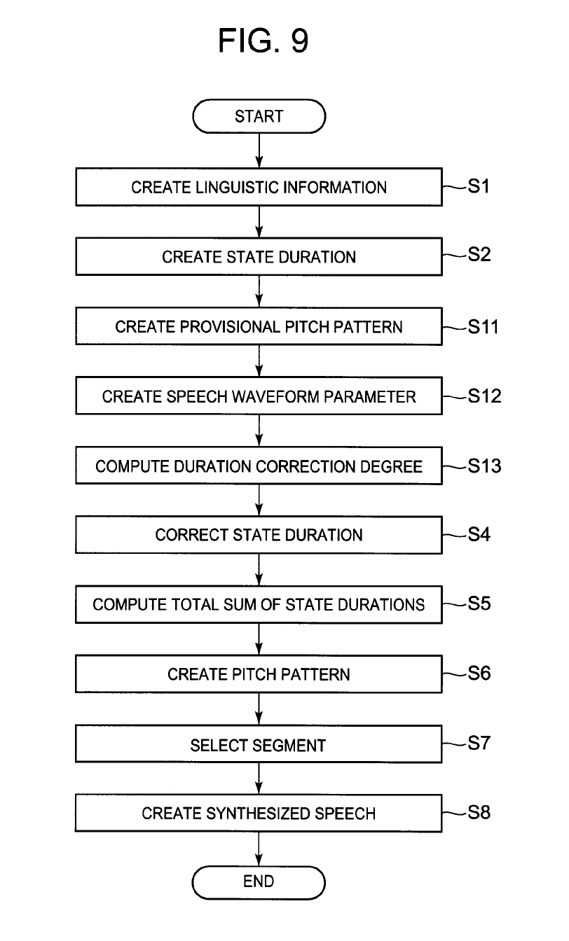

The following describes an operation of the speech synthesizer in this exemplary embodiment. FIG. 9 is a flowchart showing an example of the operation of the speech synthesizer in Exemplary Embodiment 2. First, the language processing unit 1 creates the linguistic information from the input text (step S1). The state duration creation unit 21 creates the state duration based on the linguistic information and the model parameter (step S2).

The provisional pitch pattern creation unit 28 creates the provisional pitch pattern, based on the linguistic information and the state duration (step S11). The speech waveform parameter creation unit 29 creates the speech waveform parameter, based on the linguistic information and the state duration (step S12). The duration correction degree computing unit 242 computes the duration correction degree, based on the linguistic information, the provisional pitch pattern, and the speech waveform parameter (step S13).

The subsequent process from when the state duration correction unit 22 corrects the state duration to when the waveform creation unit 5 creates the synthesized speech is the same as the process of steps S4 to S8 in FIG. 2.

As described above, according to this exemplary embodiment, the provisional pitch pattern creation unit 28 creates the provisional pitch pattern based on the linguistic information and the state duration, and the speech waveform parameter creation unit 29 creates the speech waveform parameter based on the linguistic information and the state duration. The duration correction degree computing unit 242 then computes the duration correction degree, based on the linguistic information, the provisional pitch pattern, and the speech waveform parameter.

Thus, according to this exemplary embodiment, the state duration correction degree is computed using not only the linguistic information but also the pitch pattern and the speech waveform parameter. This enables the duration correction degree to be computed more appropriately than in the speech synthesizer in Exemplary Embodiment 1. As a result, intelligible synthesized speech with higher utterance rhythm naturalness than in the speech synthesizer in Exemplary Embodiment 1 can be created.

### Exemplary Embodiment 3

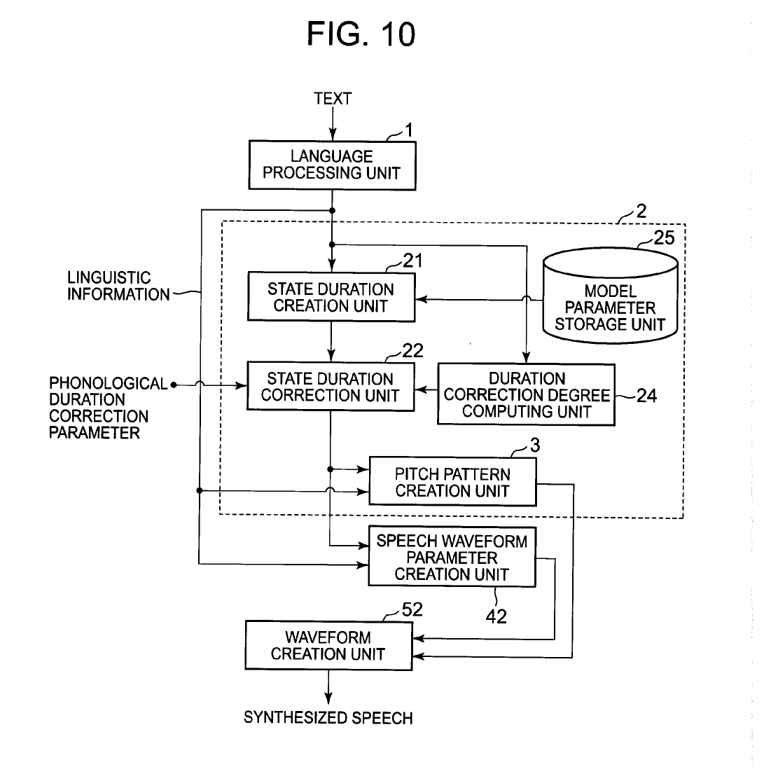

FIG. 10 is a block diagram showing an example of a speech synthesizer in Exemplary Embodiment 3 of the present invention. The same components as those in Exemplary Embodiment 1 are given the same reference signs as in FIG. 1, and their description is omitted. The speech synthesizer in this exemplary embodiment includes the language processing unit 1, the prosody creation unit 2, a speech waveform parameter creation unit 42, and a waveform creation unit 52. The prosody creation unit 2 includes the state duration creation unit 21, the state duration correction unit 22, the duration correction degree computing unit 24, the model parameter storage unit 25, and the pitch pattern creation unit 3.

That is, the speech synthesizer exemplified in FIG. 10 differs from that in Exemplary Embodiment 1, in that the phoneme duration computing unit 23 is omitted, the segment selection unit 4 is replaced with the speech waveform parameter creation unit 42, and the waveform creation unit 5 is replaced with the waveform creation unit 52.

The speech waveform parameter creation unit 42 creates a speech waveform parameter based on the linguistic information input from the language processing unit 1 and the state duration input from the state duration correction unit 22, and inputs the speech waveform parameter to the waveform creation unit 52. Spectrum information is used for the speech waveform parameter. An example of the spectrum information is a cepstrum or the like. The method of creating the speech waveform parameter by the speech waveform parameter creation unit 42 is the same as the method of creating the speech waveform parameter by the speech waveform parameter creation unit 29.

The waveform creation unit 52 creates a synthesized speech waveform, based on the pitch pattern input from the pitch pattern creation unit 3 and the speech waveform parameter input from the speech waveform parameter creation unit 42. For example, the waveform creation unit 52 may create the synthesized speech waveform by a MLSA (mel log spectrum approximation) filter described in NPL 1, though the method of creating the synthesized speech waveform by the waveform creation unit 52 is not limited to the method using the MLSA filter.

The language processing unit 1, the prosody creation unit 2 (more specifically, the state duration creation unit 21, the state duration correction unit 22, the duration correction degree computing unit 24, and the pitch pattern creation unit 3), the speech waveform parameter creation unit 42, and the waveform creation unit 52 are realized by a CPU of a computer operating according to a program (speech synthesis program). Alternatively, the language processing unit 1, the prosody creation unit 2 (more specifically, the state duration creation unit 21, the state duration correction unit 22, the duration correction degree computing unit 24, and the pitch pattern creation unit 3), the speech waveform parameter creation unit 42, and the waveform creation unit 52 may each be realized by dedicated hardware.

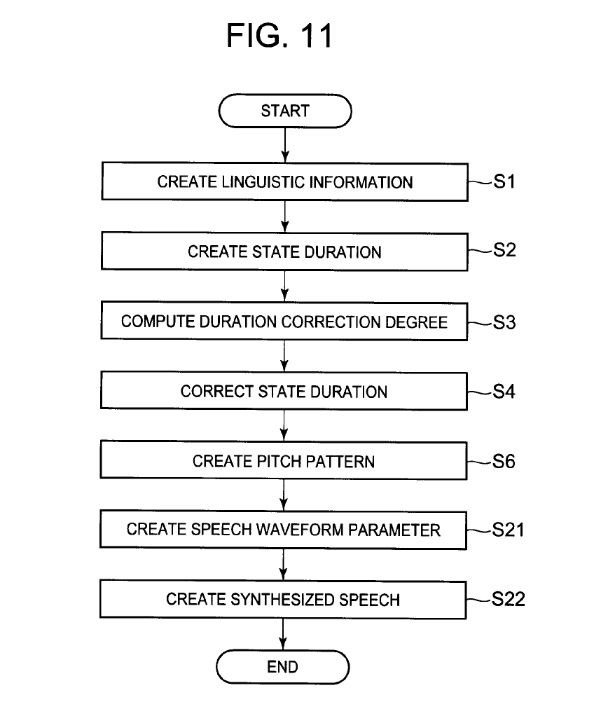

The following describes an operation of the speech synthesizer in this exemplary embodiment. FIG. 11 is a flowchart showing an example of the operation of the speech synthesizer in Exemplary Embodiment 3. The process from when the text is input to the language processing unit 1 to when the state duration correction unit 22 corrects the state duration and the process of creating the pitch pattern by the pitch pattern creation unit 3 are the same as steps S1 to S4 and S6 in FIG. 2. The speech waveform parameter creation unit 42 creates the speech waveform parameter, based on the linguistic information and the corrected state duration (step S21). The waveform creation unit 52 creates the synthesized speech waveform, based on the pitch pattern and the speech waveform parameter (step S22).

As described above, according to this exemplary embodiment, the speech waveform parameter creation unit 42 creates the speech waveform parameter based on the linguistic information and the corrected state duration, and the waveform creation unit 52 creates the synthesized speech waveform based on the pitch pattern and the speech waveform parameter. Thus, according to this exemplary embodiment, synthesized speech is created without phoneme duration creation and segment selection, unlike the speech synthesizer in Exemplary Embodiment 1. In this way, even in such a speech synthesizer that creates a speech waveform parameter by directly using a state duration as in ordinary HMM speech synthesis, intelligible synthesized speech with high utterance rhythm naturalness can be created.

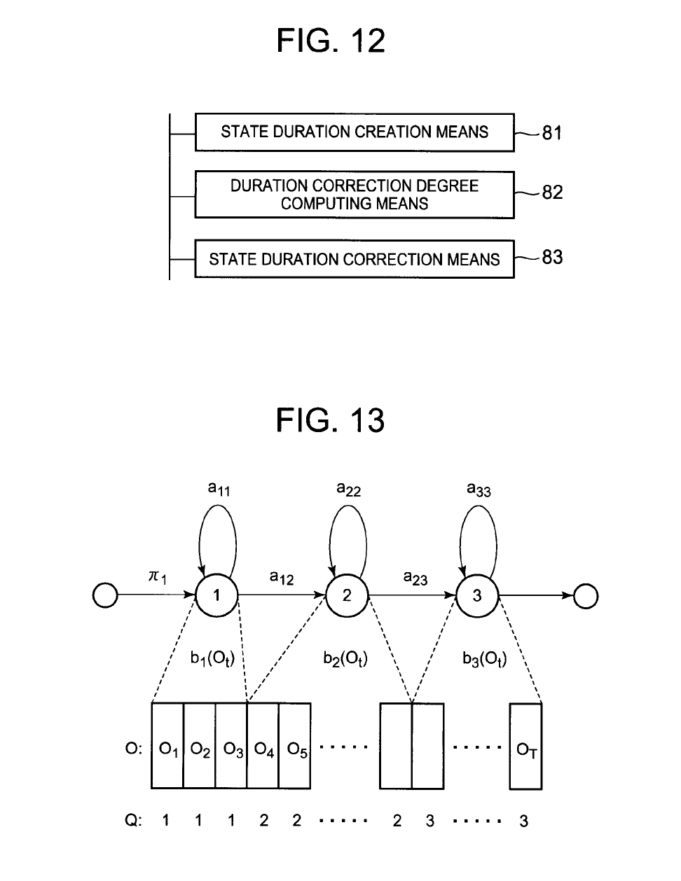

The following describes an example of a minimum structure of a speech synthesizer according to the present invention. FIG. 12 is a block diagram showing the example of the minimum structure of the speech synthesizer according to the present invention. The speech synthesizer according to the present invention includes: state duration creation means 81 (e.g. the state duration creation unit 21) for creating a state duration indicating a duration of each state in a hidden Markov model (HMM), based on linguistic information (e.g. linguistic information obtained by the language processing unit 1 analyzing input text) and a model parameter (e.g. model parameter of state duration) of prosody information; duration correction degree computing means 82 (e.g. the duration correction degree computing unit 24) for deriving a speech feature (e.g. spectrum, pitch) from the linguistic information, and computing a duration correction degree based on the derived speech feature, the duration correction degree being an index indicating a degree of correcting the state duration; and state duration correction means 83 (e.g. the state duration correction unit 22) for correcting the state duration based on a phonological duration correction parameter and the duration correction degree, the phonological duration correction parameter indicating a correction ratio of correcting a phonological duration.

With this structure, intelligible synthesized speech with high utterance rhythm naturalness can be created.

Moreover, the duration correction degree computing means 82 may estimate a temporal change degree of the speech feature derived from the linguistic information, and compute the duration correction degree based on the estimated temporal change degree. Here, the duration correction degree computing means 82 may estimate a temporal change degree of a spectrum or a pitch from the linguistic information, and compute the duration correction degree based on the estimated temporal change degree, the spectrum or the pitch indicating the speech feature.

Moreover, the state duration correction means 83 may apply a larger degree of change to the state duration of a state in which the temporal change degree of the speech feature is smaller.

Moreover, the speech synthesizer may include: pitch pattern creation means (e.g. the provisional pitch pattern creation unit 28) for creating a pitch pattern based on the linguistic information and the state duration created by the state duration creation means 81; and speech waveform parameter creation means (e.g. the speech waveform parameter creation unit 29) for creating a speech waveform parameter which is a parameter indicating a speech waveform, based on the linguistic information and the state duration. The duration correction degree computing means 82 may then compute the duration correction degree based on the linguistic information, the pitch pattern, and the speech waveform parameter. With this structure, intelligible synthesized speech with higher utterance rhythm naturalness can be created.

Moreover, the speech synthesizer may include: speech waveform parameter creation means (the speech waveform parameter creation unit 42) for creating a speech waveform parameter which is a parameter indicating a speech waveform, based on the linguistic information and the state duration corrected by the state duration correction means 83; and waveform creation means (e.g. the waveform creation unit 52) for creating a synthesized speech waveform based on a pitch pattern and the speech waveform parameter. With this structure, even in such a speech synthesizer that creates a speech waveform parameter by directly using a state duration as in ordinary HMM speech synthesis, intelligible synthesized speech with high utterance rhythm naturalness can be created.

Though the present invention has been described with reference to the above exemplary embodiments and examples, the present invention is not limited to the speech synthesizer and the speech synthesis method described in each of the above exemplary embodiment. The structures and operations of the present invention can be appropriately changed without departing from the scope of the present invention.

This application claims priority based on Japanese Patent Application No. 2010-199229 filed on Sep. 6, 2010, the disclosure of which is incorporated herein in its entirety.

### INDUSTRIAL APPLICABILITY

The present invention is suitably applied to a speech synthesizer for synthesizing speech from text.

### REFERENCE SIGNS LIST

1 language processing unit
2 prosody creation unit
3 pitch pattern creation unit
4 segment selection unit
5, 52 waveform creation unit
12 segment information storage unit
21 state duration creation unit
22 state duration correction unit
23 phoneme duration computing unit
24, 242 duration correction degree computing unit
25 model parameter storage unit
28 provisional pitch pattern creation unit
29, 42 speech waveform parameter creation unit

What is claimed is:

1.-10. (canceled)

11. A speech synthesizer comprising:
a state duration creation unit for creating a state duration indicating a duration of each state in a hidden Markov model, based on linguistic information and a model parameter of prosody information;
a duration correction degree computing unit for deriving a speech feature from the linguistic information, and computing a duration correction degree based on the derived speech feature, the duration correction degree being an index indicating a degree of correcting the state duration; and
a state duration correction unit for correcting the state duration based on a phonological duration correction parameter and the duration correction degree, the phonological duration correction parameter indicating a correction ratio of correcting a phonological duration.

12. The speech synthesizer according to claim 11, wherein the duration correction degree computing unit estimates a temporal change degree of the speech feature derived from the linguistic information, and computes the duration correction degree based on the estimated temporal change degree.

13. The speech synthesizer according to claim 12, wherein the duration correction degree computing unit estimates a temporal change degree of a spectrum or a pitch from the linguistic information, and computes the duration correction degree based on the estimated temporal change degree, the spectrum or the pitch indicating the speech feature.

14. The speech synthesizer according to claim 12, wherein the state duration correction unit applies a larger degree of change to the state duration of a state in which the temporal change degree of the speech feature is smaller.

15. The speech synthesizer according to claim 11, comprising:
a pitch pattern creation unit for creating a pitch pattern based on the linguistic information and the state duration created by the state duration creation unit; and
a speech waveform parameter creation unit for creating a speech waveform parameter which is a parameter indicating a speech waveform, based on the linguistic information and the state duration,
wherein the duration correction degree computing unit computes the duration correction degree based on the linguistic information, the pitch pattern, and the speech waveform parameter.

16. The speech synthesizer according to claim 11, comprising:
a speech waveform parameter creation unit for creating a speech waveform parameter which is a parameter indicating a speech waveform, based on the linguistic information and the state duration corrected by the state duration correction unit; and
a waveform creation unit for creating a synthesized speech waveform based on a pitch pattern and the speech waveform parameter.

17. A speech synthesis method comprising:
creating a state duration indicating a duration of each state in a hidden Markov model, based on linguistic information and a model parameter of prosody information;
deriving a speech feature from the linguistic information;
computing a duration correction degree based on the derived speech feature, the duration correction degree being an index indicating a degree of correcting the state duration; and
correcting the state duration based on a phonological duration correction parameter and the duration correction degree, the phonological duration correction parameter indicating a correction ratio of correcting a phonological duration.

18. The speech synthesis method according to claim 17, wherein when computing the duration correction degree, a temporal change degree of the speech feature derived from the linguistic information is estimated, and the duration correction degree is computed based on the estimated temporal change degree.

19. A computer readable information recording medium storing a speech synthesis program that, when executed by a processor, performs a method for:
creating a state duration indicating a duration of each state in a hidden Markov model, based on linguistic information and a model parameter of prosody information;
deriving a speech feature from the linguistic information;
computing a duration correction degree based on the derived speech feature, the duration correction degree being an index indicating a degree of correcting the state duration; and
correcting the state duration based on a phonological duration correction parameter and the duration correction degree, the phonological duration correction parameter indicating a correction ratio of correcting a phonological duration.

20. The computer readable information recording medium according to claim 19, wherein when computing the duration correction degree, a temporal change degree of the speech feature derived from the linguistic information is estimated, and the duration correction degree is computed based on the estimated temporal change degree.
